(19) United States
(12) Patent Application Publication
(10) Pub. No.: US 2005/0263540 A1
(43) Pub. Date: Dec. 1, 2005

(54) System for removing the selected product in automatic vending machines

(75) Inventor: Felix Guindulain Vidondo, Peralta (Navarra) (ES)

Correspondence Address: KLAUBER & JACKSON, 411 HACKENSACK AVENUE, HACKENSACK, NJ, 07601, US

(73) Assignee: JOFEMAR, S.A.

(21) Appl. No.: 11/117,183

(22) Filed: Apr. 28, 2005

(30) Foreign Application Priority Data
May 25, 2004 (ES) P200401255

(51) Int. Cl. G07F 11/72; B65D 83/00; B65G 59/00

(52) U.S. Cl. 221/268

(57) ABSTRACT

System for removing the selected product in automatic vending machines, in such a way that the removing system, related to the rotation of the compartment platform (3), comprises a pinion (8), geared to the perimetric toothed chain (4) of the platform (3), to whose pinion (8), by one of its ends, in a rotating eccentric position, a strip (9) which by its other end connects by means of a shaft to the removing part (7), is connected. On the other hand, the removing part (7) has a rotating curved arm (11) which in its working position, when the machine is being reloaded, abuts by one of its sides against the first product to be dispensed, releasing the removing part (7).

### OBJECT OF THE INVENTION

As expressed in the title of the present specification, the following invention refers to a system for removing the selected product in automatic vending machines, of the type of vending machines that operate by means of inserting coins and wherein the products to be dispensed are deposited in some spiral shaped compartments sitting on a rotating platform, with whose rotating movement the products are fed towards the unitary remover, in such a way that the removing system is connected to the rotating feed system of the compartment of the products to be dispensed.

Likewise, simultaneous to the rotation of the product compartment platform rotation of the removing part is produced and no specific motor is required to carry out said operation.

On the other hand, when the machine is to be reloaded, a rotating curved arm assembled on the removing part will be actuated, causing the same to abut against the first product ready to be dispensed acting as a stop and leaving the removing part free. This permits that in the rotation of the platform in the loading operation, in one direction or the other, free rotation of the removing part will be permitted without conveying any product.

### FIELD OF APPLICATION

The present specification describes a system for removing the selected product in automatic vending machines, which is specially applicable for inclusion in automatic vending machines of products contained in bottles, cans or boxes of variable shapes and sizes, that should be kept at a low temperature. Hence, the machine includes the corresponding refrigerating equipment.

### BACKGROUND OF THE INVENTION

There is a wide range of automatic vending machines of products that should be kept, for adequate preservation and/or consumption, at a low temperature, such as soft drinks, juices, water, etc., on the market.

Hence, we can consider those vending machines that have a series of compartments wherein the products are contained in cylindrical cans are stacked on their side surface in a transversal position, in such a way that the bottom can rests on a retractable strip which when dispensing takes place, retracts permitting the free fall of the can at the same time that it holds the top can to it.

By means of this removing device the cans can only have a cylindrical shape, and, besides, the free fall of the cans causes that certain beverages, due to them having been shaken, spray out of the can when the can is opened. This causes an inconvenience.

On the other hand, centering ourselves on automatic vending machines that keep the goods to be dispensed in a vertical position on a rotating platform and said elliptical shaped compartments, we can cite the documents of the same owner of the present application ES 2 025 473, ES 2 029 427 and ES 2 066 691.

Document ES 2 025 473 discloses a vending machine, comprised of a series of compartments formed by a spiral duct and a rotating product compartment platform, in such a way that the removing part ends in a L-shaped body between whose wings the product to be dispensed is positioned and there is a microdetector of the product. The removing part remains rotating by means of a shaft and by its end opposite the removal it has a retaining catch of the closing door of the corresponding product compartment duct.

Document ES 2 029 427 discloses a vending machine likewise comprised of a series of compartments formed by a spiral duct and a rotating product compartment platform, provided with a toothed perimetric chain wherein a pinion that transmits movement to it from a motor, is geared, in such a way that the removing part ends in a L-shaped body between whose wings the product to be dispensed is positioned. There is a microdetector of the product that activates a motor for removing the product towards a fixed platform for collecting by the user.

Document ES 2 066 691 describes a system for filling automatic vending machines, which is applicable in automatic vending machines that have a series of compartments formed by a spiral duct and a rotating product compartment platform, in such a way that the spiral that defines the duct remains open, said access mouth permitting placement of the products on one side or the other, depending on the direction of rotation of the platform. When loading the machine the outside feed spiral of the removing part is the first one that is filled after the existing products that are still cold are maintained by a stop and they will be the first ones to be dispensed. Once the machine has been loaded the outside spiral will reverse the direction of rotation of the platform and the products will be conveyed towards the center of the spiral duct.

Hence, the removing part is actuated by a motor that will be activated by means of a micro when it detects that the product to be dispensed is perfectly positioned between the wings of the L-shaped removing body.

### DESCRIPTION OF THE INVENTION

The present specification describes a system for removing the selected product in automatic vending machines, being of the type of automatic vending machines that operate by means of inserting coins and wherein the goods to be dispensed are deposited in some spiral shaped compartments sitting on a rotating platform provided with a perimetric toothed chain wherein a pinion transmitting movement from a motor, is geared, with whose rotating movement the goods are fed towards the unitary remover. In this way, the removing system related to the rotation of the compartment platform, comprises a pinion, geared to the perimetric toothed chain of the platform, to whose pinion a strip connects by one of its ends in a rotating eccentric position and by its other end the strip connects by means of a shaft to the removing part. Said removing part has a rotating curved arm that in its working position, when the machine is reloaded, by one of its sides, abuts against a first product to be dispensed releasing the removing part.

In the operation for removing a product, the feeding of the corresponding rotating product compartment platform causes complete rotation of the driving pinion of the removing part causing the removal of the product and its return to the inoperative position, in such a way that assembly of the specific components for driving the removing part, such as a motor, is avoided. This represents a saving.

On the other hand, when the machine is reloaded with the rotating curved arm in its working position abutting by one of its sides against the first product to be dispensed, this will permit free actuation of the removing part without conveying any of the products, in other words, continuous rotation of the removing part is permitted during rotation of the product compartment platform during reloading. None of the products are conveyed by the removing part.

In a first stage of loading the product compartment platform by rotating it in the direction of the removal operation, an accumulation of goods after the first one is produced until the outside section of the spiral is filled.

In a second stage of loading the product compartment platform by rotating it in the direction contrary to the removal operation and the goods accumulated in the outside section of the spiral abut against a stopping strip, the goods move towards the center of the spiral and the accumulation thereof from the center towards the outside until the entire compartment duct is filled, takes place.

The stopping strip of the goods accumulated in the outermost spiral section, assembled on the periphery of the product compartment platform, is aided by a spring that impels it towards the inside permitting the passing of the goods in the rotation of the platform in the removal operation.

In order to complete the description that is going to be made, and for the purpose of providing a better understanding of the characteristics of the invention, the present specification is accompanied by a set of drawings, in whose figures the most characteristic details of the invention are represented in an illustrative and non-restrictive manner.

### BRIEF DESCRIPTION OF THE DRAWINGS

FIG. 1 shows a plan view of a compartment for the placement of goods, wherein one can see the product compartment platform, the spiral sheet that defines the compartment duct, the actuating motor of the platform and the unitary removing system of the products in its inoperative position and being arranged to carry out removal.

FIG. 2 shows a plan view of a compartment for placement of goods, wherein one can see the product compartment platform, the spiral sheet that defines the product compartment duct, the actuating motor of the platform and the unitary removing system of the products, wherein removal is being carried out.

FIG. 3 shows a plan view of a compartment for placement of goods, wherein one can see the product compartment platform, the spiral sheet that defines the compartment duct, the actuating motor of the platform and the unitary removing system returning to the inoperative position thereof once removal has taken place.

FIG. 4 shows a plan view of a compartment for placement of goods, wherein one can see how in the reloading operation the curved arm, assembled on the removing part, in its working position, with one of its sides abuts against the first product to be dispensed, releases the removing part.

FIG. 5 shows a plan view of the compartment for placement of goods of the preceding figure, wherein one can see how in the reloading operation, in a first step, the products accumulate after the products that have not yet been dispensed.

FIG. 6 shows a plan view of the compartment for placement of goods of the preceding figure, wherein one can see how in the reloading operation, in a second step, the products accumulate towards the center of the spiral duct.

### DESCRIPTION OF A PREFERRED EMBODIMENT

In view of the commented figures and according to the numbering used, starting from an automatic vending machine (1) comprised of a series of compartments according to different levels, the compartments (2) are defined by a rotating compartment platform (3) of the products (12) conveyed by a spiral fixed duct and the cited platform (3) is provided with a perimetric toothed chain (4) wherein a pinion (5) that transmits movement from a motor (6) is geared. We can see how the removing system is defined by a unitary removing part (7) connected, by means of a strip (9), to a pinion (8) geared in the toothed chain (4).

Hence, the removing system, related to the rotation of the compartment platform (3) is comprised of a pinion (8) geared to a perimetric toothed chain (4) of the platform (3), to whose pinion (8), a strip (9) is connected by one of its ends in a rotating eccentric position and by its other end it connects by means of a shaft (10) to the removing part (7).

On the other hand, said removing part (7) has a rotating curved arm (11) that in its working position, in other words, in the moment when the machine is being reloaded, by one of its sides abuts against the first product (13) to be dispensed releasing the free part (7).

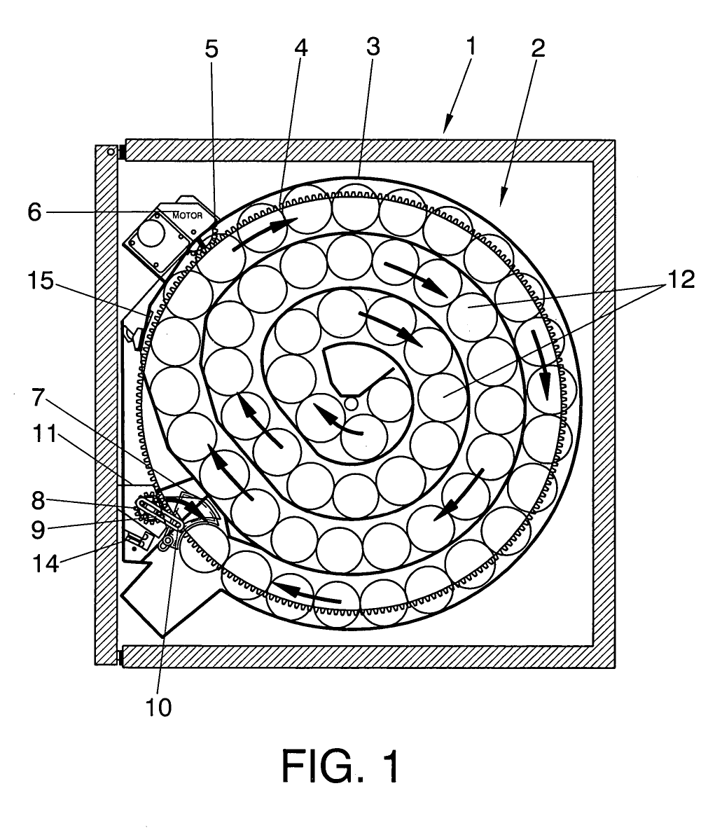

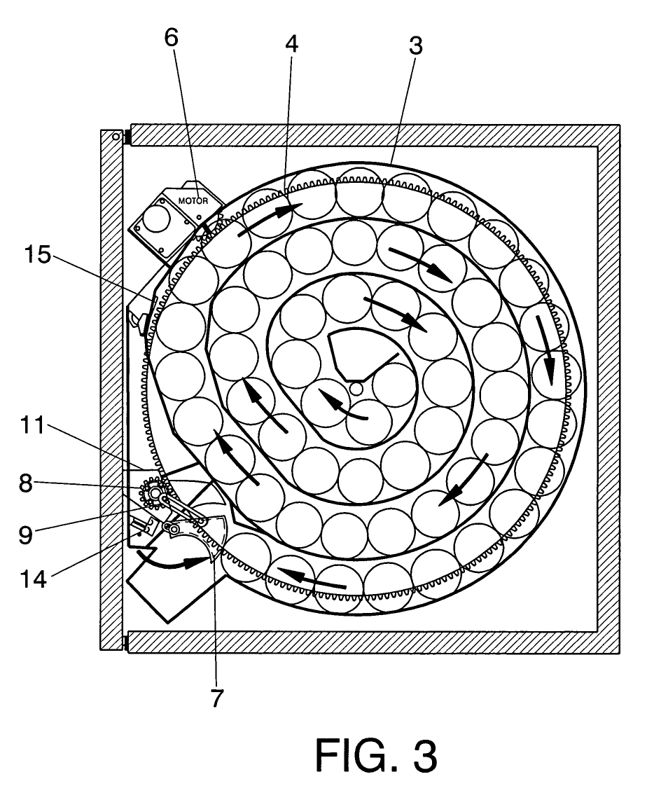

In this way, in accordance with FIGS. 1 and 3, we can see how, in the product removal operation, the feeding of the corresponding rotating product (12) compartment platform (3) products produces a complete rotation of the pinion (8) for actuating the removing part (7) causing the removal of the first product (13) and the return of the removing part to its inoperative position. Besides, the removing part itself (7) acts as a stop of the second product until the removing part (7) returns to its inoperative position placing itself on the following product to be removed.

Hence, the rotating movement itself of the product compartment platform (3) caused by the pinion (5), geared into the toothed chain (4), driven by the motor (6), causes rotation of the pinion (8), and consequently, actuation of the removing part (7) in order to materialize the removal of the corresponding product.

On the other hand, the system is provided with a micro (14) that detects the complete rotation of the pinion (8) causing the platform (3) to stop moving.

Logically, the removing part (7) will be able to have different shapes and sizes, especially its surface abutted against the different products to be dispensed, which will be able to be adapted in order to be complementary thereto.

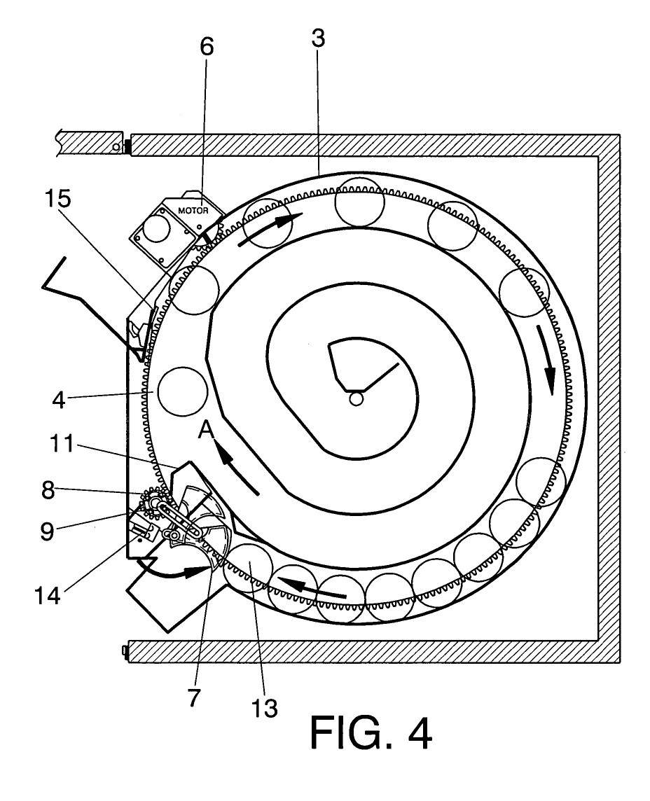

When reloading the different compartments of the machine with the rotating curved arm (11) in its working position, as represented in FIGS. 4 to 6, abutting by one of its sides against the first product to be dispensed, the free actuation of the removing part (7) will be permitted without any conveyance of the products. In other words, this permits rotation of the platform (3) and the free rotation of the removing part (7) without the latter conveying any product.

In accordance with FIGS. 4 to 6 in the reloading of the machine, one can see how the curved arm (11) abuts against the first product ready to be dispensed. The removing part (7) remains free permitting rotation thereof without conveying any product, in such a way that, in a first reloading step or stage, the rotation of the platform (3) in the direction of arrow A, in other words, in the direction of rotation of the removal operation, will cause the products to accumulate after the products still exist inside the machine. The curved arm (11) acts as a stop.

On the other hand, in a second reloading step or stage, the rotation of the platform (3) in the direction of arrow B, that is to say, in the direction contrary to the removal of the goods, the products will be conveyed towards the center of the spiral duct accumulating as of there.

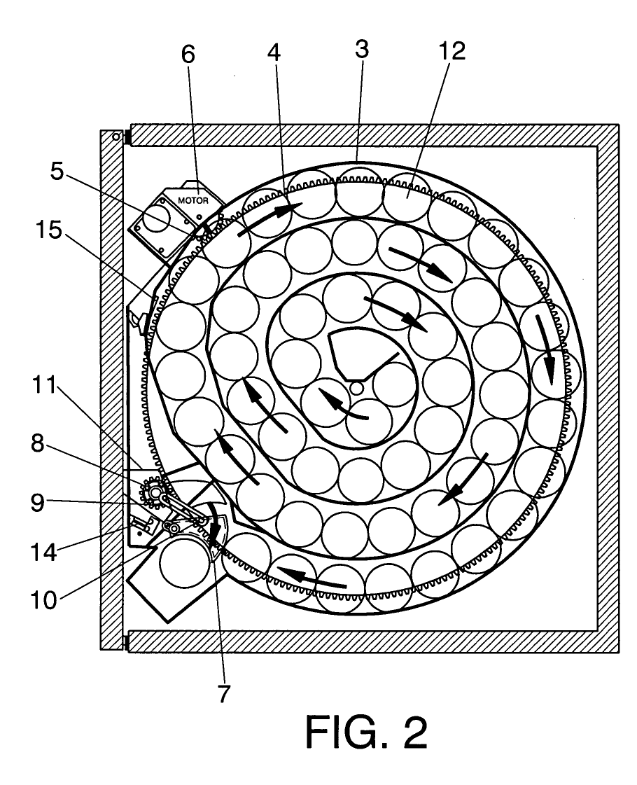

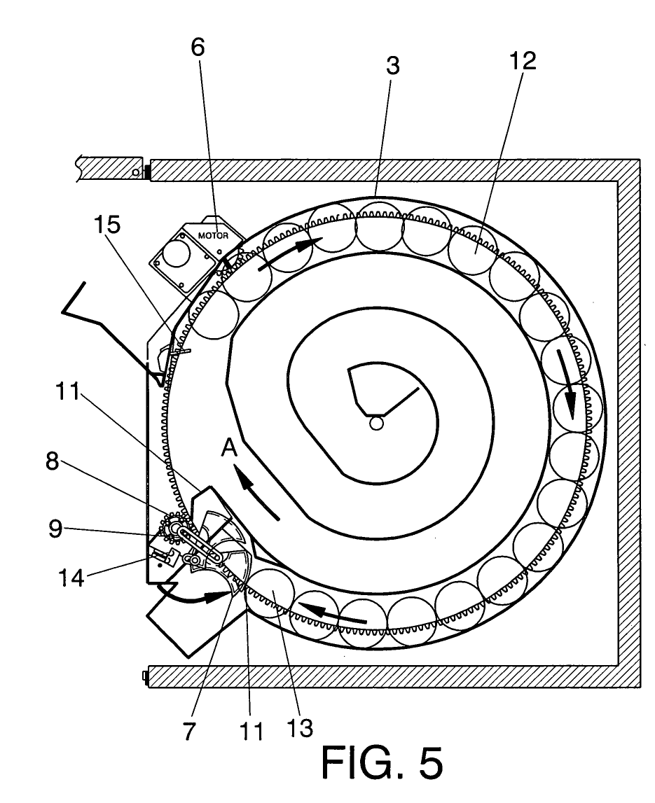

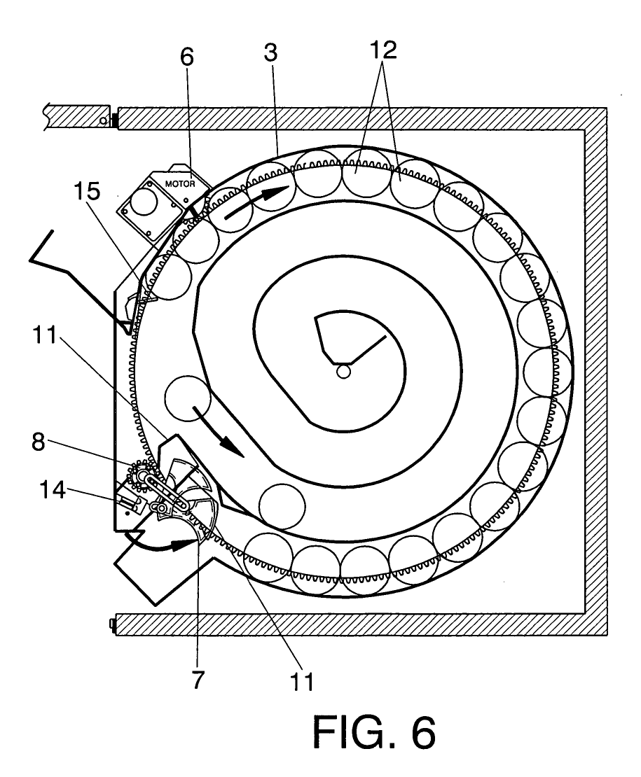

Likewise, we can see how the reloading system includes a small rotating strip (15) assembled on the outermost spiral of the product compartment duct defined by a fixed spiral sheet, the strip (15) being aided by a strip that impels it towards the inside of the platform (3), in such a way that in rotation in the normal direction of the platform (3) in the removal (arrow A), the weight itself of the products cause the withdrawal of the strip (15) (FIGS. 1 to 4), whereas in the rotation of platform (3) in the opposite direction (arrow B); in its reloading position (FIGS. 5 and 6), the strip (15) acts as a stop and brake preventing the passing of the products.

1. System for removing the selected product in automatic vending machines, being of the type of automatic vending machines that operate by means of inserting coins and wherein the goods to be dispensed are deposited in some spiral shaped compartments sitting on a rotating platform provided with a perimetric toothed chain wherein a pinion transmitting movement from a motor, is geared, with whose rotating movement the goods are fed towards the unitary remover wherein the removing system, related to the rotation of the compartment platform, comprises a pinion, geared to the perimetric toothed chain of the platform, to whose pinion a strip connects by one of its ends in a rotating eccentric position and by its other end the strip connects by means of a shaft to the removing part, said removing part having a rotating curved arm that in its working position, when the machine is reloaded, by one of its sides, it abuts against a first product to be dispensed releasing the removing part.

2. System for removing the selected product in automatic vending machines, according to claim 1, wherein in the operation for removing a product, the feeding of the corresponding rotating product compartment platform causes a complete rotation of the pinion actuating the removing part causing the removal of the product and the return of the removing part to its inoperative position.

3. System for removing the selected product in automatic vending machines, according to claim 1, wherein in the reloading operation of the machine with the rotating curved arm in its working position abutting by one of its sides against the first product to be dispensed, will permit the free actuation of the removing element without conveying any of the products.

4. System for removing the selected product in automatic vending machines, according to claim 1 wherein in a first reloading stage with the product compartment platform rotating in the removal actuating direction, the accumulation of products is produced after the first one arranged for removal until the outside section of the spiral is filled.

5. System for removing the selected product in automatic vending machines, according to claim 1 wherein in a second reloading stage with the product compartment platform rotating in the direction contrary to the removal operation and the products accumulated in the outside section of the spiral abutting against a stopping strip, causes the movement of the products towards the center of the spiral and the accumulation thereof from the center towards the outside until the entire compartment duct is filled.

6. System for removing the selected product in automatic vending machines, according to claim 1 wherein the stopping strip of the goods accumulated in the outermost spiral section, assembled on the periphery of the product compartment platform is aided by a spring that impels it towards the inside permitting the passing of products in the rotation of the platform in the removal operation.

7. System for removing the selected product in automatic vending machines, according to claim 3, wherein in a first reloading stage with the product compartment platform rotating in the removal actuating direction, the accumulation of products is produced after the first one arranged for removal until the outside section of the spiral is filled.

8. System for removing the selected product in automatic vending machines, according to claim 3, wherein in a second reloading stage with the product compartment platform rotating in the direction contrary to the removal operation and the products accumulated in the outside section of the spiral abutting against a stopping strip, causes the movement of the products towards the center of the spiral and the accumulation thereof from the center towards the outside until the entire compartment duct is filled.

9. System for removing the selected product in automatic vending machines, according to claim 5, wherein the stopping strip of the goods accumulated in the outermost spiral section, assembled on the periphery of the product compartment platform is aided by a spring that impels it towards the inside permitting the passing of products in the rotation of the platform in the removal operation.

10. System for removing the selected product in automatic vending machines, according to claim 8, wherein the stopping strip of the goods accumulated in the outermost spiral section, assembled on the periphery of the product compartment platform is aided by a spring that impels it towards the inside permitting the passing of products in the rotation of the platform in the removal operation.
